(19) United States
(12) Patent Application Publication
(10) Pub. No.: US 2005/0194298 A1
(43) Pub. Date: Sep. 8, 2005

(54) Pressurized fluid sample injector and method of injecting fluid samples

(75) Inventors: James E. Usowicz, Douglas, MA (US); Theodore D. Ciolkosz, Milton, MA (US); Russell Keene, Sudbury, MA (US); Daniel J. McCormick, Westford, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTEMENTS LIMITED, New Castle, DE (US)

(21) Appl. No.: 11/072,906

(22) Filed: Mar. 4, 2005

Related U.S. Application Data
(63) Continuation of application No. PCT/US03/28249, filed on Sep. 10, 2003.
(60) Provisional application No. 60/409,836, filed on Sep. 11, 2002.

(51) Int. Cl. B01D 15/08

(52) U.S. Cl. 210/98; 210/659; 73/61.55; 422/63; 210/198.2

(57) ABSTRACT

The present invention is a pressurized fluid sample injector system consisting of a sample needle, multiport valve, sample loop, metering syringe and a pressure source. The method and apparatus of the present invention provides increased speed of sample transport into the sample loop by pressurizing the fluid in the system and metering the sample into the sample loop. The elevated system pressure allows the fluids to be moved faster than the vapor pressure would normally allow in a system at ambient pressure.

### CROSS REFERENCE TO RELATED APPLICATIONS

This application claims benefit of and is a continuation of International Application No. PCT/US03/028249, filed Sep. 10, 2003 and designating the United States, which claims benefit of and priority to U.S. Provisional Application No. 60/409,836, filed Sep. 11, 2002. The entire contents of these applications are incorporated herein by reference.

### BACKGROUND OF THE INVENTION

In liquid chromatography sample injection, a sample is moved from the tip of a needle or capillary and into a sample loop by aspirating (pulling fluid) through a system of tubes and into a sample loop. The flow rate at which this fluid can be pulled through the system of tubes is directly related to the vapor pressure of the fluid. If the fluid is “pulled” too quickly, the fluid vaporizes and causes undesirable results in sample integrity as well as sample positioning. This phenomenon forces the flow rate of sample loading to remain below the flow rate that will cause vaporization. In most cases this limitation adds a significant amount of time to the overall sample injection cycle time.

In the present invention, sample movement speed is increased significantly by pressurizing the fluid system, thus avoiding vaporization of the fluid. This process allows the sample to be transported through the system faster then in normally aspirated sample preparation, thus reducing the overall cycle time between sample injections.

### SUMMARY OF THE INVENTION

The invention is a pressurized sample injector system, which utilizes elevated pressure to aid sample delivery to a sample loop. It consists of a sample needle for aspirating a sample within a container. A multiport valve is connected to the sample needle and a sample loop is connected to the multiport valve. A metering syringe is also connected to the multiport valve. A pressure source such as a pressure assist pump is substantially sealed to the sample needle creating a substantially sealed path between the pressure assist pump, across the sample loop and to the metering syringe. The pressure source can be of any known type including some constant pressure source.

With the multiport valve in a first position, a sample is aspirated from a container holding the sample into the sample needle. The needle tip is connected to a pressure source. The sample then is moved from the sample needle to a sample loop by creating a pressure differential across the path from the pressure source to the metering syringe. The sample next moves from the sample loop to an analytical column by a high pressure pump after the multiport valve is moved to a second position. The second position provides for the metering syringe to disconnect from the multiport valve and for the pump and analytical column to connect to the multiport valve and thereby, the sample loop.

### BRIEF DESCRIPTION OF THE DRAWINGS

FIG. 1 depicts part of one embodiment of the apparatus during sample aspiration.

FIG. 2 depicts the steps of sample aspiration.

FIG. 3 depicts the apparatus during pressurization.

FIG. 4. depicts the pressurization of a sample.

FIG. 5. depicts the apparatus during metering.

FIG. 6. depicts the metering of the sample.

### DETAILED DESCRIPTION OF THE DRAWINGS

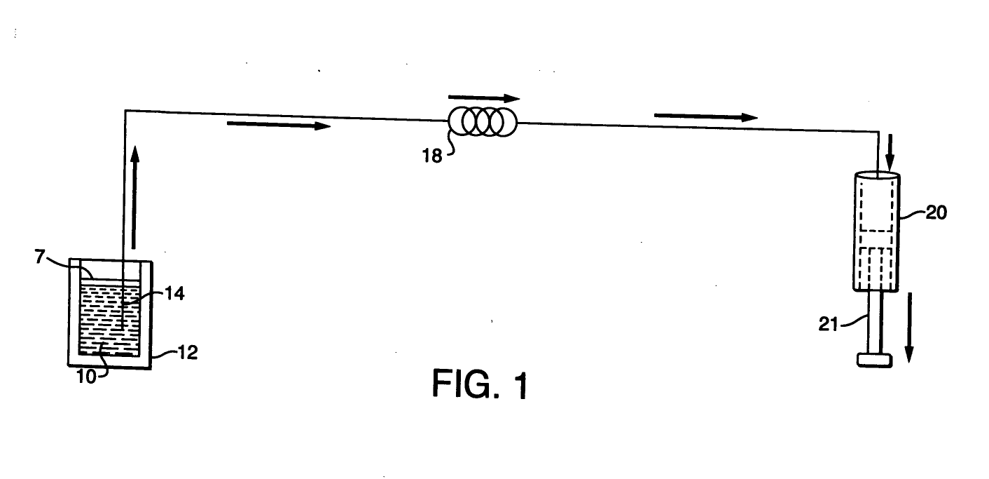

In FIG. 1 the invention is shown during aspiration of a sample 10. The sample 10 is in a container 12 adapted for this purpose. A sample needle 14 or capillary is placed into the sample and a portion of the sample is aspirated into the needle.

A multiport valve 16 is connected to the sample needle in a first position. A sample loop 18 is also connected to the multiport valve 16. In the first position, the sample needle 14 and sample loop 18 are connected via the multiport valve 16. Also connected to the multiport valve 16 in the first position is a metering syringe 20. The metering syringe 20 is a pump configured to move the sample through the system by drawing a metered amount of fluid from the sample container and into the needle tip 14. The metering syringe can be any pump so suited.

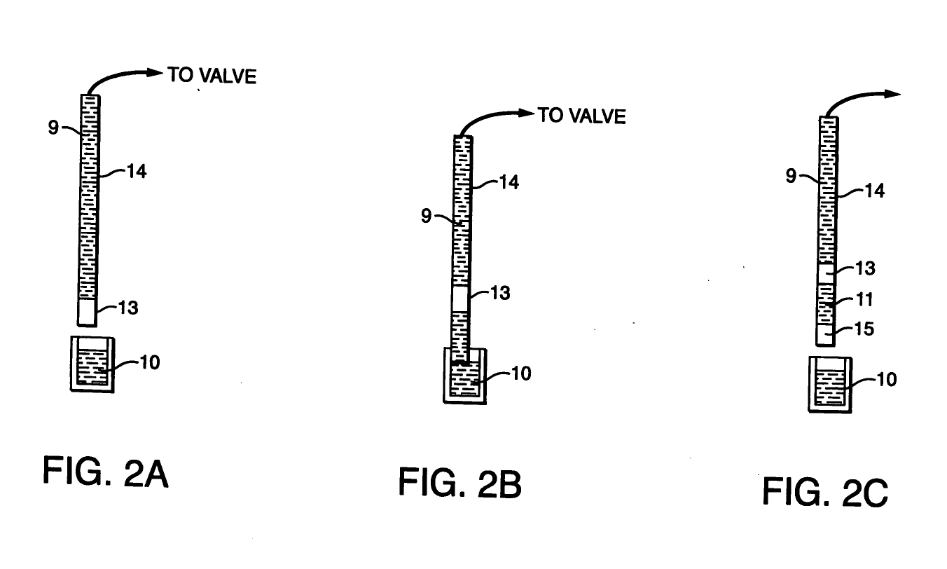

As shown in the embodiment depicted by FIG. 2 during aspiration, at 2a the metering syringe is drawn back to create a volume of air at the sample needle 14. At 2b the sample needle 14 is placed into the sample 10 and the metering syringe 20 is further pulled back a metered amount which draws a predetermined measured portion of the sample 10 into the sample needle 14. In one embodiment shown at 2c, the sample needle 14 is then lifted from the sample 10 and a post-sample air gap is drawn into the sample needle 14 by the metering syringe 20.

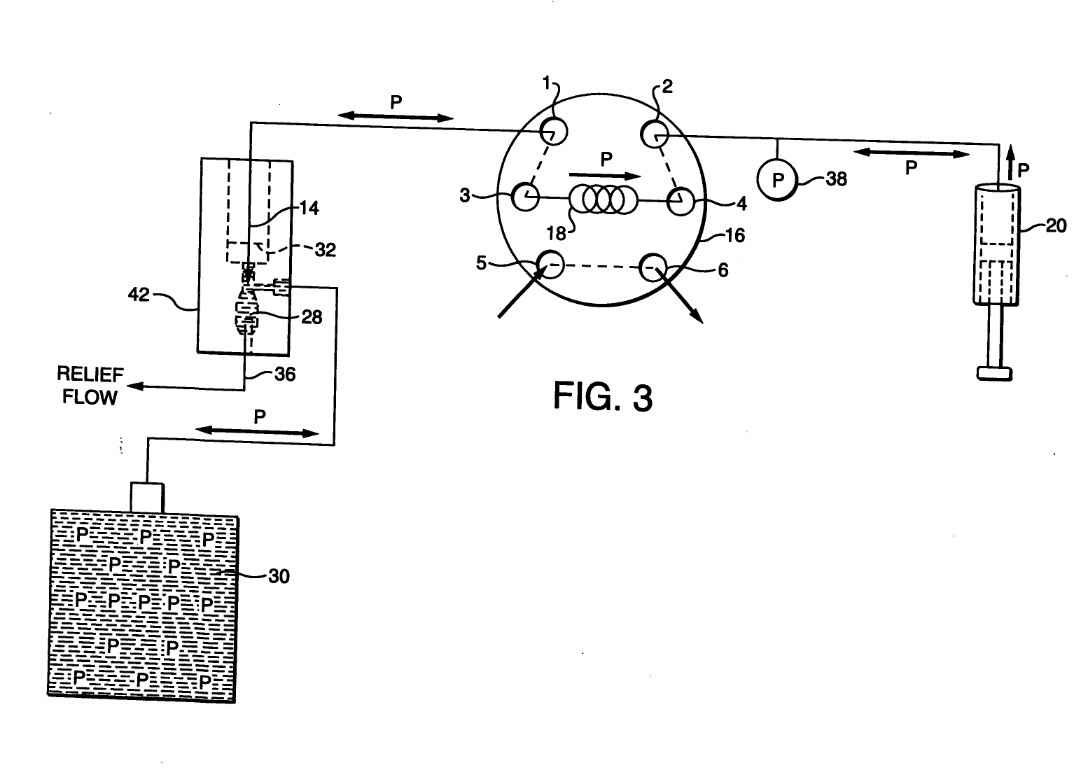

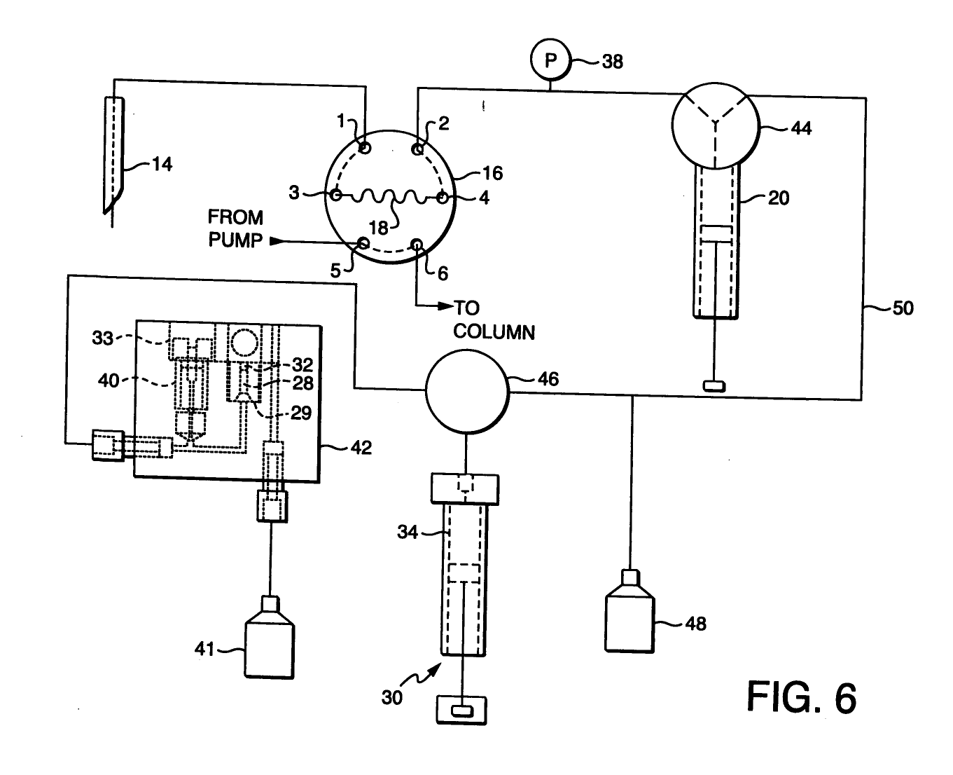

FIG. 3 depicts one embodiment of the apparatus during pressurization of the sample while in the sample needle 14. With the multiport valve 16 still in the first position, the sample needle 14 is connected to a pressure source 30. In one embodiment shown in FIG. 6, the pressure source 30 is a wash syringe also used to wash the sample path, although any pump or pressure source so suited may be used.

The pressure source 30 provides pressure across the entire sample path from the pressure source 30 through the sample loop 18 and to the metering syringe 20.

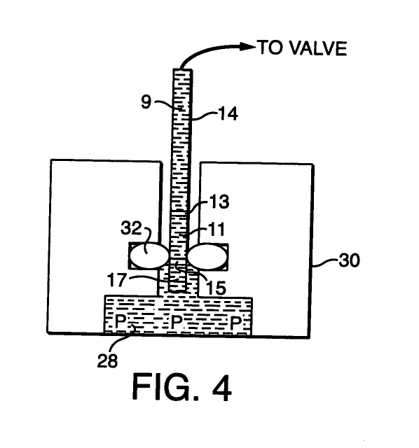

FIG. 4 depicts the sample being pressurized in the sample needle 14. In the preferred embodiment, the sample needle 14 is sealed to the pressure source 30 by an O-ring 32. A line-to-line seal, lip seal or any other means for substantially sealing the sample needle 14 to the pressure source 30 is appropriate.

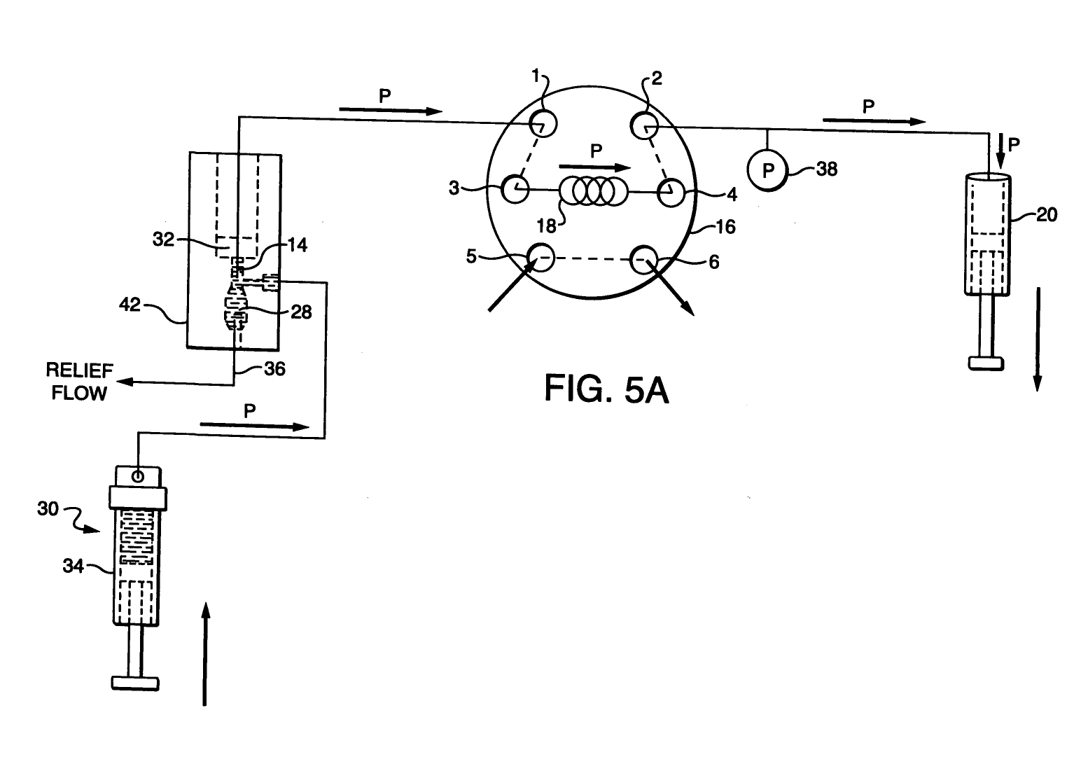

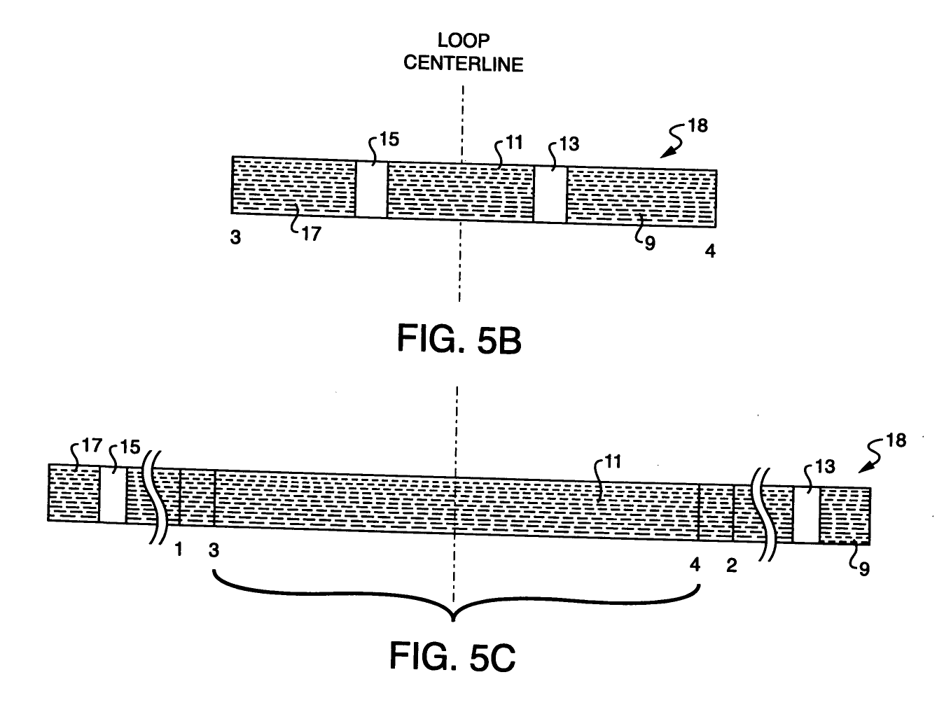

In FIG. 5 the portion of the sample that has been aspirated and pressurized is drawn into the sample loop 18 by drawing back the metering syringe 20 and creating a pressure differential across the sample path. The aspirated sample moves rapidly into the sample loop 18 without vaporizing due to the elevated pressure of the sealed sample path. All of the connections of the present invention substantially seal the sample path from ambient pressure.

Pressure is exerted by the pressure source 30 through the sealed needle tip 14, sealed by an O-ring 32. When the metering syringe 20 is drawn back, the pressurized sample rapidly moves to the sample loop 18. The metering syringe is drawn down a metered amount to appropriately place the sample within the sample loop.

Since the sample 10 is pressurized within the sample path, the sample 10 does not vaporize when it moves into the sample loop 18.

In one embodiment depicted in FIG. 6, a pressure regulating vent 40 is used to maintain a substantially constant pressure during the sample's pressurization and movement into the sample loop. In a preferred embodiment, a constant pressure source is utilized that eliminates the need for pressure relief vents or valves.

In the invention, the volume of fluid between the metering syringe 20 and the pressure source 30 is pressurized to assist sample movement. The sample needle 14 with sample aspirated is sealed in the wash block 42 via an O-ring seal 32. Pressure is created in the system by dispensing fluid from the pressure source 30, here a wash syringe, and is held constant by the pressure regulating vent 40. With the system at the operating pressure, the metering syringe meters back a pre-determined volume in order to move the sample from the tip of the sample needle 14 and into the sample loop 18. After the sample is positioned in the sample loop, the multiport valve 16 is actuated and the sample is moved by a high pressure pump to a column.

The invention allows a sample to be moved into a sample loop in less time then it takes in normally aspirated sample preparation, where transport speed is constrained by the vapor pressure of the fluids transported. Sample positioning accuracy is also improved over other chromatography systems as well. While the above is a description of specific embodiments of the present invention, modifications, alternatives and equivalents may be used while remaining within the scope and spirit of the following claims.

1. A pressurized fluidic sample injector system consisting of:
a sample needle for aspirating a sample within a container;
a multiport valve connected to the sample needle;
a sample loop connected to the multiport valve;
a metering syringe connected to the multiport valve; and
a pressure source that substantially seals with the sample needle whereby a pressure differential may be created across the sample and the metering syringe.

2. A sample injector as in claim 1 wherein:
the multiport valve is connected to an analytical column and a pump.

3. A sample injector as in claim 1 wherein:
the multiport valve is a high pressure injector valve.

4. A sample injector as in claim 1 wherein:
the pressure source provides a constant pressure.

5. A sample injector as in claim 4 wherein:
the constant pressure source is a gas pressure source.

6. A sample injector as in claim 1 wherein:
the pressure source has a waste port

7. A sample injector as in claim 1 wherein:
an O-ring substantially seals the sample needle to the pressure source.

8. A sample injector as in claim 1 wherein:
a lip seal substantially seals the sample needle to the pressure source.

9. A sample injector as in claim 1 wherein:
a line to line seal substatically seals the sample needle to the pressure source.

10. A sample injector as in claim 1 further comprising:
a pressure transducer between the multiport valve and the metering syringe.

11. A sample injector as in claim 1 further comprising:
a pressure regulating vent for holding the pressure in the system substantially constant.

12. A sample injector as in claim 1 further comprising:
a wash system between the pressure source and the metering syringe.

13. A method of transferring a sample from a container to an analytical column comprising:
aspirating a sample from a container into a sample needle;
substantially sealing from ambient pressure a sample path from a pressure source through the sample needle, across the sample, across a sample loop, to a metering syringe;
creating a pressure differential across the sample path;
moving the sample across the sample path from the sample needle to the sample loop by moving a metered amount of sample through the sample path using the metering syringe; and
moving the sample from the sample loop to an analytical column by a pump.

14. A method as in claim 13 wherein:
switching a multiport valve connected to the sample loop and metering syringe in a first position, to a second position whereby the analytical column and the pump are connected to the sample loop and the metering syringe is disconnected from the multiport valve.

15. A method as in claim 13 wherein:
the pressure created across the sample path is substantially held constant by a pressure regulating vent.

16. A method as in claim 13 wherein:
a gas pressure source creates the pressure differentiated.

17. A method as in claim 13 wherein:
a pressure assist pump creates the pressure differentiated.
